(19) United States
(12) Patent Application Publication
(10) Pub. No.: US 2005/0274013 A1
(43) Pub. Date: Dec. 15, 2005

(54) Low cost vehicle heat exchange devices manufactured from conductive loaded resin-based materials

(75) Inventor: Thomas Aisenbrey, Littleton, CO (US)

Correspondence Address: STEPHEN B. ACKERMAN, 28 DAVIS AVENUE, POUGHKEEPSIE, NY, 12603, US

(73) Assignee: Integral Technologies, Inc.

(21) Appl. No.: 11/143,798

(22) Filed: Jun. 2, 2005

Related U.S. Application Data
(60) Provisional application No. 60/578,415, filed on Jun. 9, 2004.

(51) Int. Cl. C08J 7/04; B21D 53/02

(52) U.S. Cl. 29/890.046; 29/890.03

(57) ABSTRACT

Vehicle heat exchanger devices are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are metals or conductive non-metals or metal plated non-metals. The micron conductive fibers may be metal fiber or metal plated fiber. Further, the metal plated fiber may be formed by plating metal onto a metal fiber or by plating metal onto a non-metal fiber. Any platable fiber may be used as the core for a non-metal fiber. Superconductor metals may also be used as micron conductive fibers and/or as metal plating onto fibers in the present invention.

### RELATED PATENT APPLICATIONS

This Patent Application is related to U.S. patent application INT04-030A, Ser. No. ______, and filed on ______, which is herein incorporated by reference in its entirety.

This Patent Application claims priority to the U.S. Provisional Patent Application No. 60/578,415, filed on Jun. 9, 2004, which is herein incorporated by reference in its entirety.

This Patent Application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to vehicle heat exchanger devices and, more particularly, to vehicle heat exchanger devices molded of conductive loaded resin-based materials comprising micron conductive powders, micron conductive fibers, or a combination thereof, substantially homogenized within a base resin when molded. This manufacturing process yields a conductive part or material usable within the EMF, thermal, acoustic, or electronic spectrum(s)

(2) Description of the Prior Art

Internal combustion engines generate a substantial amount of heat during operation. Therefore, vehicles powered by internal combustion engines include a means for dissipating excess heat from the engine such that the engine is not damaged. Referring now to FIG. 1, a schematic of an exemplary vehicle engine cooling system 10 is illustrated. Two heat exchange devices, the radiator 12 and heater core 14, are depicted in this schematic. The fan 16 is also indicated. A fan shroud, not shown, also is typical to an engine cooling system. In most modern engines, liquid coolant is circulated through the engine block 18, the engine cylinder head 20, and subsequently through the radiator 12 in order to cool the engine. When coolant temperature rises above a set temperature, the fan 16 engages to force additional airflow and thus additional cooling across the radiator 12. The primary purpose of the heater core 14 is to heat the vehicle passenger compartment on demand. The heater core 14 is actually a heat exchange device which circulates engine coolant in order to draw heat from the coolant much like the radiator 12. Air is blown across the heater core 14 thus warming the air for use in the passenger compartment and cooling the engine coolant which ultimately cools the engine. Therefore, when the vehicle interior heater is in use, the heater core 14 acts as an additional heat exchange device to cool the engine. In the prior art, the heat exchange devices comprise metals, such as aluminum or steel. These metals are effective as conductors of thermal energy but have several disadvantages including complexity of manufacture, weight, and corrosion. A primary objective of the present invention is to provide vehicle heat exchange devices with reduced complexity of manufacture and reduced weight yet with improved resistance to corrosion.

Several prior art inventions relate to vehicle heat exchange components and systems. U.S. Pat. No. 6,189,492 B1 to Brown teaches an automotive fan shroud that is integrally formed with liquid reservoirs made of plastics resin. This invention also teaches the use of a reinforced polypropylene resin that is reinforced with approximately 40% talcum powder to improve its strength and rigidity. U.S. Pat. No. 5,704,326 to Minegishi et al teaches an air induction system for an internal combustion engine that utilizes air flow bodies and a collector body formed of a molded resin material. U.S. Patent Publication US 2004/0069446 A1 to Horiuchi teaches an integrated heat exchanger that incorporates a radiator for use in engine cooling and a condenser for use in the air-conditioning system that utilizes a resin tank between the two structures. U.S. Pat. No. 5,220,809 to Voss teaches a cooling apparatus for an automotive air conditioning system electrical controller that incorporates the use of a chill block made of non-heat conductive plastic.

### SUMMARY OF THE INVENTION

A principal object of the present invention is to provide an effective vehicle heat exchange device.

A further object of the present invention is to provide a method to form a vehicle heat exchange device.

A further object of the present invention is to provide a vehicle heat exchange device that is lower in weight than prior art devices.

A further object of the present invention is to provide a vehicle heat exchange device that is easier to manufacture than prior art devices.

A further object of the present invention is to provide a vehicle heat exchange device that is will not corrode.

A further object of the present invention is to provide a vehicle heat exchange device molded of conductive loaded resin-based materials.

A yet further object of the present invention is to provide a vehicle heat exchange device molded of conductive loaded resin-based material where the thermal or electrical characteristics can be altered or the visual characteristics can be altered by forming a metal layer over the conductive loaded resin-based material.

A yet further object of the present invention is to provide methods to fabricate a vehicle heat exchange device from a conductive loaded resin-based material incorporating various forms of the material.

A yet further object of the present invention is to provide a method to fabricate a vehicle heat exchange device from a conductive loaded resin-based material where the material is in the form of a fabric.

In accordance with the objects of this invention, a vehicle heater exchanger device is achieved. The device comprises a circulatory piping and a plurality of fins attached to the circulatory piping. The circulatory piping comprises a conductive loaded, resin-based material comprising conductive materials in a base resin host.

Also in accordance with the objects of this invention, a vehicle heater exchanger device is achieved. The device comprises a circulatory piping and a plurality of fins attached to the circulatory piping. The circulatory piping comprises a conductive loaded, resin-based material comprising conductive materials in a base resin host. The percent by weight of the conductive materials is between about 20% and about 50% of the total weight of the conductive loaded resin-based material.

Also in accordance with the objects of this invention, a vehicle heater exchanger device is achieved. The device comprises a circulatory piping and a plurality of fins attached to the circulatory piping. The circulatory piping comprises a conductive loaded, resin-based material comprising micron conductive fiber in a base resin host. The percent by weight of the micron conductive fiber is between about 20% and about 50% of the total weight of the conductive loaded resin-based material.

Also in accordance with the objects of this invention, a method to form a vehicle heater exchanger device is achieved. The method comprises providing a conductive loaded, resin-based material comprising conductive materials in a resin-based host. The conductive loaded, resin-based material is molded into a vehicle heater exchanger device comprising a circulatory piping; and a plurality of fins attached to the circulatory piping. The circulatory piping comprises the conductive loaded resin-based material.

Also in accordance with the objects of this invention, a method to form a vehicle heater exchanger is achieved. The method comprises providing a conductive loaded, resin-based material comprising conductive materials in a resin-based host. The percent by weight of the conductive materials is between 20% and 40% of the total weight of the conductive loaded resin-based material. The conductive loaded, resin-based material is molded into a vehicle heater exchanger device comprising a circulatory piping and a plurality of fins attached to the circulatory piping. The circulatory piping comprises the conductive loaded resin-based material.

Also in accordance with the objects of this invention, a method to form a vehicle heater exchanger is achieved. The method comprises providing a conductive loaded, resin-based material comprising micron conductive fiber in a resin-based host. The percent by weight of said micron conductive fiber is between 20% and 50% of the total weight of the conductive loaded resin-based material. The conductive loaded, resin-based material is molded into a vehicle heater exchanger device comprises a circulatory piping and a plurality of fins attached to the circulatory piping. The circulatory piping comprises the conductive loaded resin-based material.

### BRIEF DESCRIPTION OF THE DRAWINGS

In the accompanying drawings forming a material part of this description, there is shown:

FIG. 1 illustrates an exemplary prior art vehicle engine cooling system in schematic form.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold vehicle heat exchanger devices of a conductive loaded resin-based material.

FIG. 7 illustrates a first preferred embodiment of the present invention showing a vehicle radiator comprising conductive loaded resin-based material.

FIG. 8 illustrates a second preferred embodiment of the present invention showing a vehicle heater core formed of conductive loaded resin-based material.

FIG. 9 illustrates a third preferred embodiment of the present invention showing a heat exchanger used in vehicle air conditioning systems comprising conductive loaded resin-based material.

FIG. 10 illustrates a fourth preferred embodiment of the present invention showing vehicle hoses formed of conductive loaded resin-based material.

FIG. 11 illustrates a fifth preferred embodiment of the present invention showing a vehicle fan shroud formed of conductive loaded resin-based material.

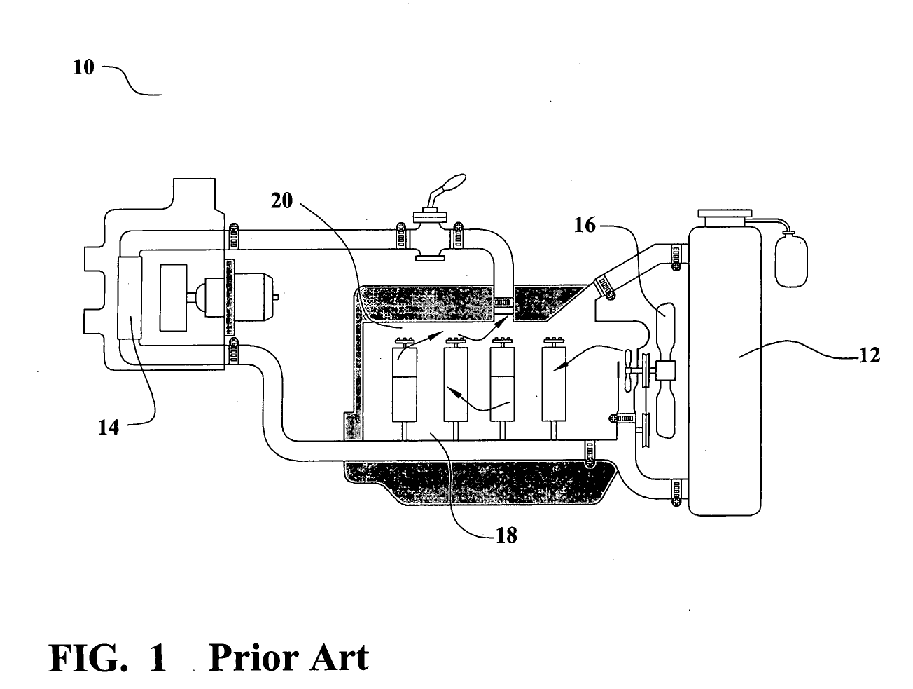

### DESCRIPTION OF THE PREFERRED EMBODIMENTS

This invention relates to vehicle heat exchanger devices molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of vehicle heat exchanger devices fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the vehicle heat exchanger devices are substantially homogenized together using molding techniques and or methods such as injection molding, over-molding, insert molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of vehicle heat exchanger devices significantly lowers the cost of materials and the design and manufacturing processes used to hold ease of close tolerances, by forming these materials into desired shapes and sizes. The devices can be manufactured into infinite shapes and sizes using conventional forming methods such as injection molding, over-molding, or extrusion, calendaring, or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. Exemplary micron conductive powders include carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The addition of conductive powder to the micron conductive fiber loading may increase the surface conductivity of the molded part, particularly in areas where a skinning effect occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, or the like, or combinations thereof. Exemplary metal plating materials include, but are not limited to, copper, nickel, cobalt, silver, gold, palladium, platinum, ruthenium, and rhodium, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion, or calendaring, to create desired shapes and sizes. The molded conductive loaded resin-based materials can also be stamped, cut or milled as desired to form create the desired shape form factor(s) of the vehicle heat exchanger devices. The doping composition and directionality associated with the micron conductors within the loaded base resins can affect the electrical and structural characteristics of the devices and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming devices of rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in vehicle heat exchanger device applications as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, vehicle heat exchanger devices manufactured from the molded conductor loaded resin-based material can provide added thermal dissipation capabilities to the application. For example, heat can be dissipated from electrical devices physically and/or electrically connected to vehicle heat exchanger devices of the present invention.

As a significant advantage of the present invention, vehicle heat exchanger devices constructed of the conductive loaded resin-based material can be easily interfaced to an electrical circuit or grounded. In one embodiment, a wire can be attached to a conductive loaded resin-based device via a screw that is fastened to the device. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the vehicle heat exchanger device and a grounding wire.

Where a metal layer is formed over the surface of the conductive loaded resin-based material, any of several techniques may be used to form this metal layer. This metal layer may be used for visual enhancement of the molded conductive loaded resin-based material article or to otherwise alter performance properties. Well-known techniques, such as electroless metal plating, electro metal plating, metal vapor deposition, metallic painting, or the like, may be applied to the formation of this metal layer. If metal plating is used, then the resin-based structural material of the conductive loaded, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

The ferromagnetic conductive loading is in the form of fiber, powder, or a combination of fiber and powder. The micron conductive powder may be metal fiber or metal plated fiber. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive loading may be combined with a non-ferromagnetic conductive loading to form a conductive loaded resin-based material that combines excellent conductive qualities with magnetic capabilities.

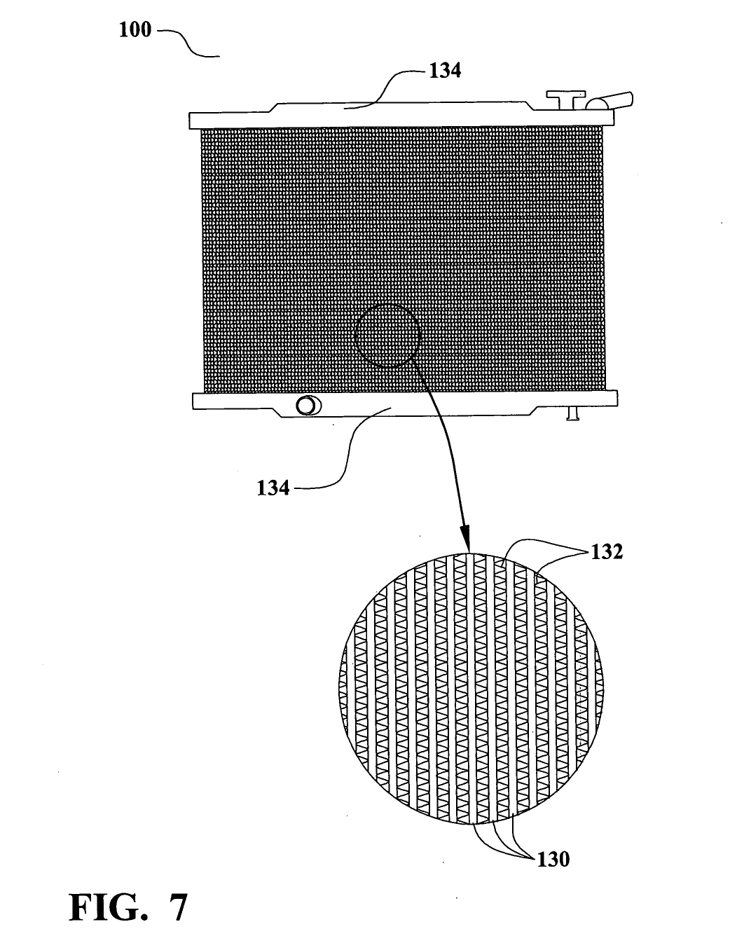

Referring now to FIG. 7, a first preferred embodiment of the present invention is illustrated. A radiator 100 comprising conductive loaded resin-based material is shown. The radiator 100 construction includes a plurality of parallel tubes 130 which carry the engine coolant and a plurality of fins 132 which dissipate heat from the tubes as is conventional. The unique aspect of the present invention is the use of conductive loaded resin-based material in this application. One preferred embodiment of the radiator 100 is to construct the entire radiator 112 including the tubes 130, fins 132, and the surrounding encasement 134 of conductive loaded resin-based material. In this case, the conductive loaded resin-based components of the radiator 112 are formed using molding techniques as described previously. The conductive loaded resin-based material tubes 130 are, for example, extruded. The conductive loaded resin-based material fins 132 are injection molded, or alternately stamped, and formed into fins 132 which provide a large amount of surface area in a compact space. During the fabrication process, the fins 132 are joined to the tubes 130 in order to maximize heat transfer between the tubes and fins. This joining process is accomplished by over-molding or ultrasonic welding or by other means known to those skilled in the art. As an additional fabrication option, the fins 132 and tubes 130 are concurrently molded into a one-piece fin/tube unit. This unit is then attached to the conductive loaded resin-based material encasement 134 which contains a cavity for fluid passage.

According to one embodiment, the radiator 100 utilizes conductive loaded resin-based material for all of the components as described above except that the interfaces of the radiator 112 to one or more outside components are reinforced with metal. For example, the radiator interface to the radiator cap, not shown, is accomplished by adding a metal piece to the radiator encasement 134 to accommodate the subsequent engagement of the radiator cap, not shown. In another embodiment, metal fins, such as the aluminum fins which are often found in the prior art, are combined with conductive loaded resin-based material tubes 130. The tubes 130 are molded onto the metal fins thus providing efficient heat transfer from the engine coolant running through the tubes 130 to the air moving past the fins. This fin/tube unit is then attached to the conductive loaded resin-based material encasement 134. As is common in the automotive industry, the radiator 112 may also contain a separate fluid circuit for transmission oil coolant. Alternately, the transmission oil is cooled in a separate radiator-type heat exchanger also comprising conductive loaded resin-based material as a part of the present invention. The conductive loaded resin-based material of the present invention hereby provides a low cost radiator and/or transmission oil cooler for which the economics of fabrication make it advantageous for use in vehicles. Weight is a further advantage of conductive loaded resin-based material heat exchange devices. The heat exchange devices of the present invention offer a significant weight savings when compared to their metal counterparts commonly found in use today. This results in lower vehicle weight and consequently provides increased fuel efficiency.

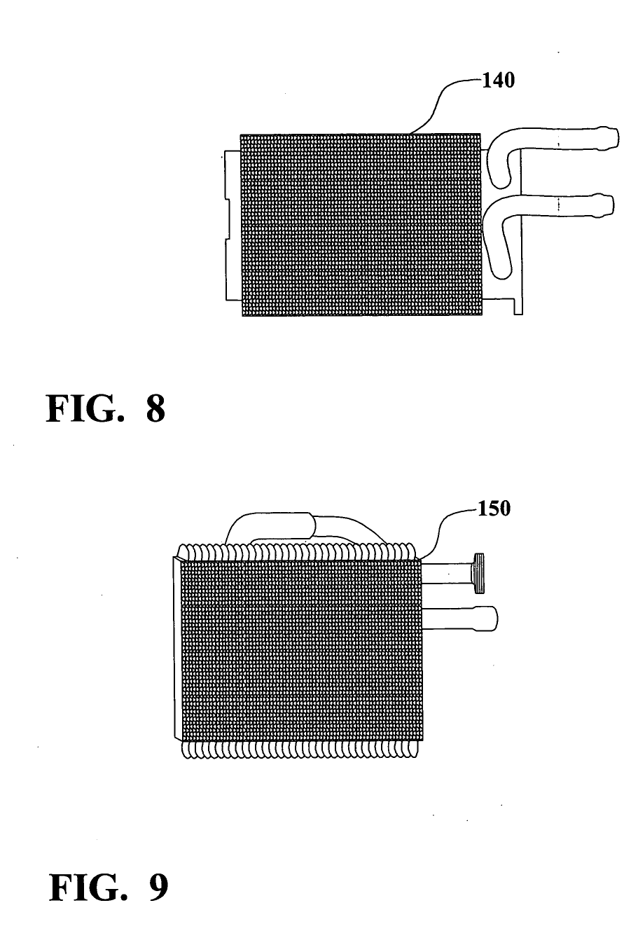

Referring now to FIGS. 8 and 9, second and third preferred embodiments of the present invention are illustrated. A low cost heater core 140 comprising conductive loaded resin-based material is shown in FIG. 8. The heater core 140 is used in vehicles to heat the passenger compartment on demand. A heat exchanger 150 for a vehicle air conditioning system is shown in FIG. 9. Both the heater core 140 and heat exchanger 150 are of similar construction and operating principles to the radiator as discussed in FIG. 7. Each is constructed, in part or in whole, of conductive loaded resin-based material of the present invention.

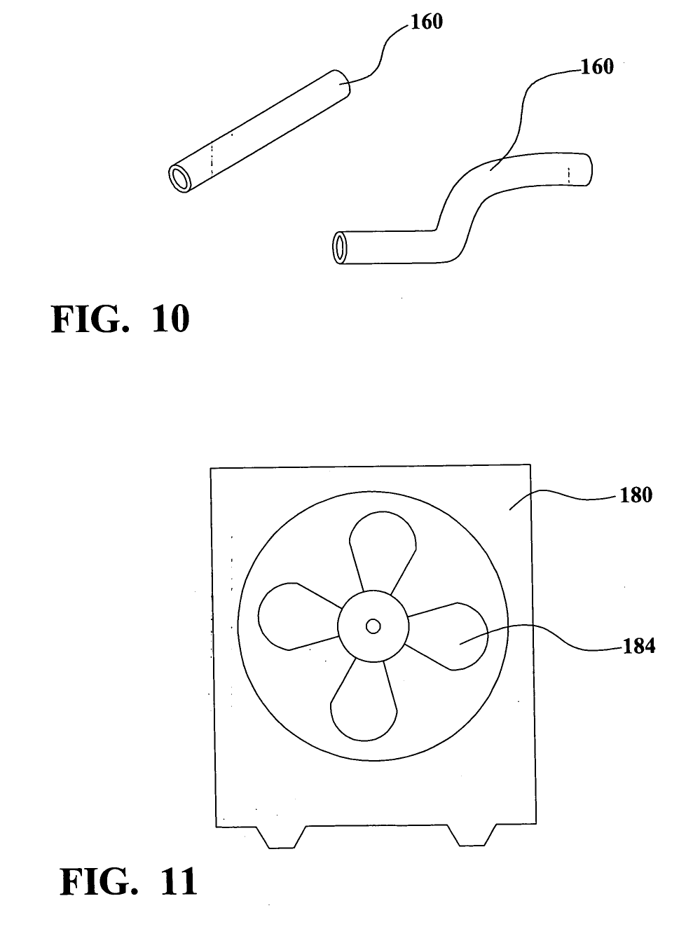

Referring now to FIG. 10, a fourth preferred embodiment of the present invention is illustrated. Hoses 160 comprising conductive loaded resin-based material are shown. Hoses 160 carry liquid coolant or air as a part of the many heating and/or cooling applications within the modern vehicle. These conductive loaded resin-based material hoses 160 replace other hoses, tubes, and duct-work typically constructed of plastics, rubber, metal, or a combination thereof. There are several advantages of conductive loaded resin-based material in this application. These hoses 160 offer a significant weight savings when compared to their metal counterparts commonly used today. This results in lower vehicle weight and consequently provides increased fuel efficiency. An additional benefit is the relative ease and low cost of manufacture. Conductive loaded resin-based material hoses 160 are formed by extrusion, injection molding, or other means. They are readily fabricated in almost any desired shape and size befitting the particular application. This includes, but is not limited to, round cross-section, rectangular cross-section, straight lengths of tubing, and tubing curved to fit a particular space available in the vehicle. In certain applications, flexible tubing is beneficial to vehicle assembly and/or service. Conductive loaded resin-based material hoses 160 are made to remain flexible in vehicle applications where this is desired. Varying degrees of flexibility are achieved by varying the base resin material and the doping composition and directionality associated with the micron conductors.

Referring now to FIG. 11, a fifth preferred embodiment of the present invention is illustrated. A vehicle fan shroud 180 comprising conductive loaded resin-based material is shown. Such a fan shroud 180 is used to surround the fan 184 which draws air across the radiator fins. The conductive loaded resin-based material fan shroud 180 provides the advantages of thermal dissipation and structural integrity when compared to common plastic fan shrouds often found in the prior art. As an additional design option, the fan blades 184 comprise conductive loaded resin-based material. The shroud 180 or the fan blades 184 are easily formed by injection or blow molding the conductive loaded resin-based material.

As a further embodiment a metal layer may be formed overlying the conductive loaded resin-based material of any of the above-described heat exchanger devices. In any vehicle heat exchange device, if a metal layer, not shown, is used, this metal layer may be formed by plating or by coating. If the method of formation is metal plating, then the resin-based structural material of the conductive loaded, resin-based material is one that can be metal plated. There are very many of the polymer resins that can be plated with metal layers.

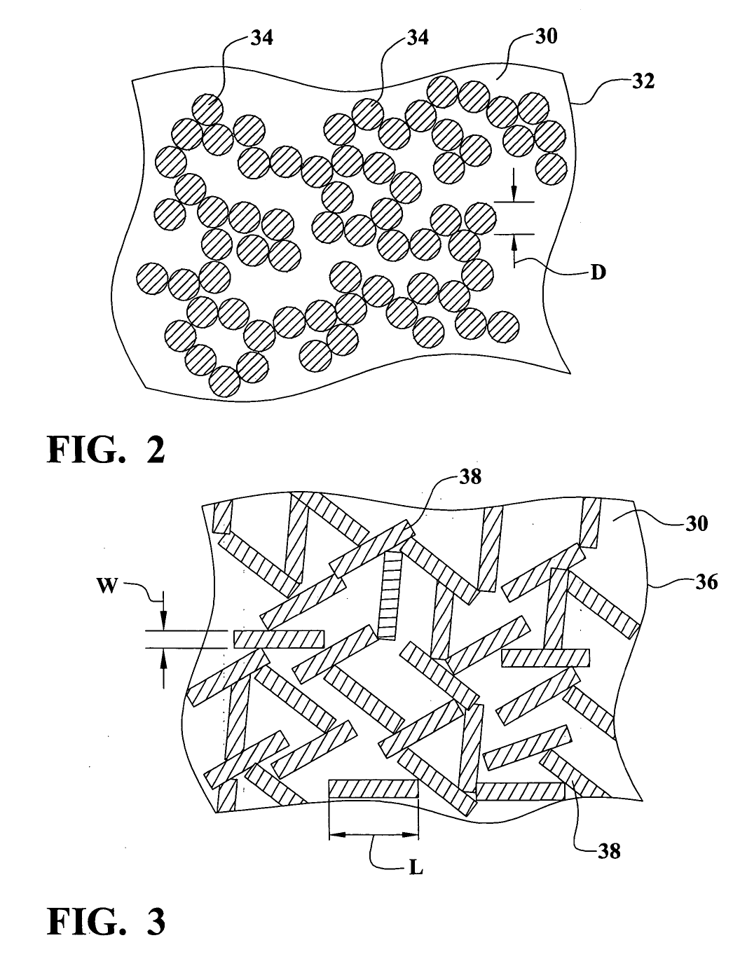

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, or the like, or combinations thereof. Exemplary metal plating materials include, but are not limited to, copper, nickel, cobalt, silver, gold, palladium, platinum, ruthenium, and rhodium, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

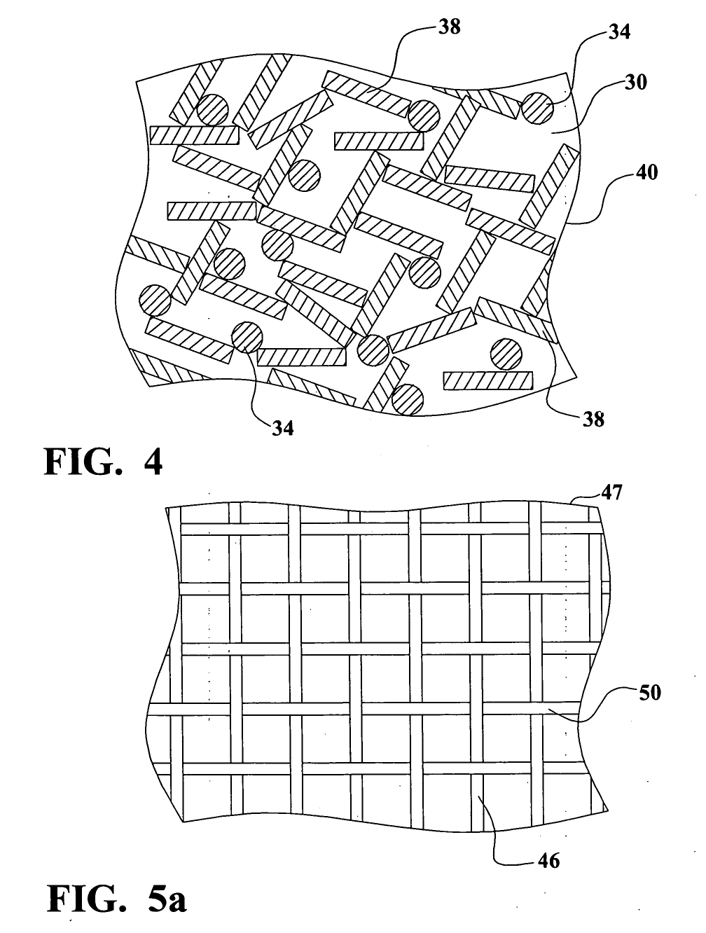

These conductor particles and/or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any spectrum, thermal, acoustic, or electronic frequency. Referring now to FIG. 4, another preferred embodiment of the present invention is illustrated where the conductive materials comprise a combination of both conductive powders 34 and micron conductive fibers 38 substantially homogenized together within the resin base 30 during a molding process.

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

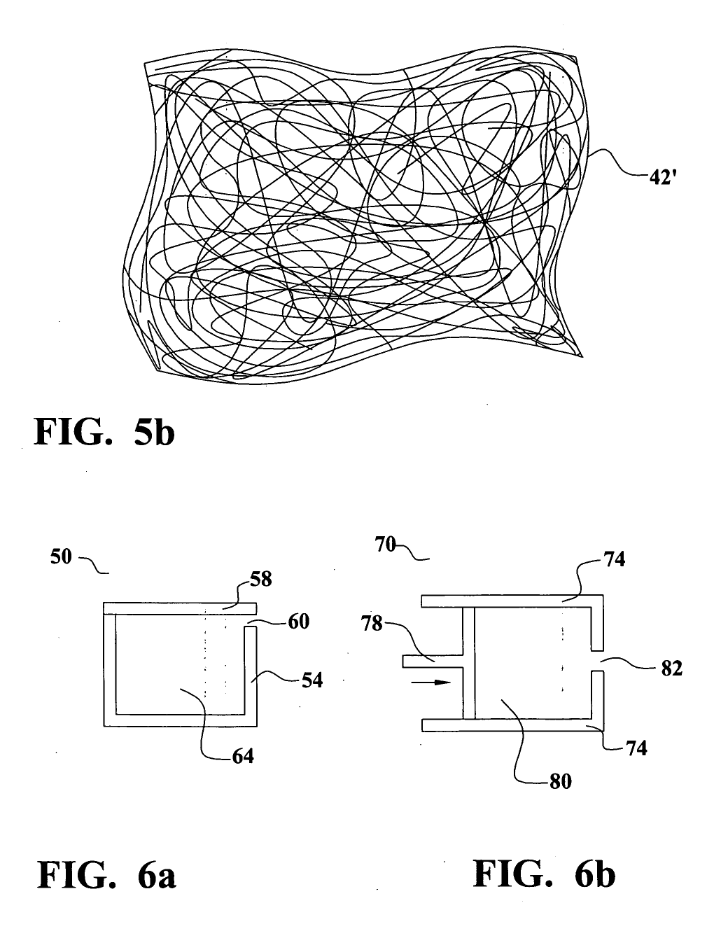

Vehicle heat exchanger devices formed from conductive loaded resin-based materials can be formed or molded in a number of different ways including injection molding, extrusion, calendaring, or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the vehicle heat exchanger devices are removed.

FIG. 6b shows a simplified schematic diagram of an extruder 70 for forming vehicle heat exchanger devices using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. Effective vehicle heat exchange devices are achieved. Methods to form vehicle heat exchange devices are also achieved. The vehicle heat exchange devices are lower in weight and easier to manufacture than prior art devices. The vehicle heat exchange devices will not corrode. The thermal or electrical characteristics of the devices can be altered or the visual characteristics can be altered by forming a metal layer over the conductive loaded resin-based material.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A method to form a vehicle heater exchanger device, said method comprising:
providing a conductive loaded, resin-based material comprising conductive materials in a resin-based host; and
molding said conductive loaded, resin-based material into a vehicle heater exchanger device comprising:
a circulatory piping; and
a plurality of fins attached to said circulatory piping wherein said circulatory piping comprises said conductive loaded resin-based material.

2. The method according to claim 1 wherein the percent by weight of said conductive materials is between about 20% and about 50% of the total weight of said conductive loaded resin-based material.

3. The method according to claim 1 wherein said conductive materials comprise micron conductive fiber.

4. The method according to claim 2 wherein said conductive materials further comprise conductive powder.

5. The method according to claim 1 wherein said conductive materials are metal.

6. The method according to claim 1 wherein said conductive materials are non-conductive materials with metal plating.

7. The method according to claim 1 wherein said step of molding comprises:
injecting said conductive loaded, resin-based material into a mold;
curing said conductive loaded, resin-based material; and
removing said vehicle heater exchanger device from said mold.

8. The method according to claim 1 wherein said step of molding comprises:
loading said conductive loaded, resin-based material into a chamber;
extruding said conductive loaded, resin-based material out of said chamber through a shaping outlet; and
curing said conductive loaded, resin-based material to form said vehicle heater exchanger device.

9. A method to form a vehicle heater exchanger, said method comprising:
providing a conductive loaded, resin-based material comprising conductive materials in a resin-based host wherein the percent by weight of said conductive materials is between 20% and 40% of the total weight of said conductive loaded resin-based material; and
molding said conductive loaded, resin-based material into a vehicle heater exchanger device comprising:
a circulatory piping; and
a plurality of fins attached to said circulatory piping wherein said circulatory piping comprises said conductive loaded resin-based material.

10. The method according to claim 9 wherein said conductive materials are nickel plated carbon micron fiber, stainless steel micron fiber, copper micron fiber, silver micron fiber or combinations thereof.

11. The method according to claim 9 wherein said conductive materials comprise micron conductive fiber and conductive powder.

12. The method according to claim 11 wherein said conductive powder is nickel, copper, or silver.

13. The method according to claim 11 wherein said conductive powder is a non-metallic material with a metal plating.

14. The method according to claim 9 wherein said plurality of fins comprises said conductive loaded resin-based material.

15. The device according to claim 9 wherein said conductive loaded resin-based material is further plated with a metal layer.

16. The device according to claim 9 further comprising a frame supporting said circulatory piping wherein said frame comprises said conductive loaded resin-based material.

17. The method according to claim 9 wherein said conductive loaded resin-based material further comprises a ferromagnetic material.

18. A method to form a vehicle heater exchanger, said method comprising:
providing a conductive loaded, resin-based material comprising micron conductive fiber in a resin-based host wherein the percent by weight of said micron conductive fiber is between 20% and 50% of the total weight of said conductive loaded resin-based material; and
molding said conductive loaded, resin-based material into a vehicle heater exchanger device comprising:
a circulatory piping; and
a plurality of fins attached to said circulatory piping wherein said circulatory piping comprises said conductive loaded resin-based material.

19. The method according to claim 18 wherein said micron conductive fiber is stainless steel.

20. The method according to claim 18 wherein said micron conductive fiber has a diameter of between about 3 μm and about 12 μm and a length of between about 2 mm and about 14 mm.
